(19) United States
(12) Patent Application Publication
(10) Pub. No.: US 2021/0229310 A1
(43) Pub. Date: Jul. 29, 2021

(54) ASSEMBLY TO IMMOBILISE A CHAINSAW

(71) Applicant: Peter Lazar, Janesville, WI (US)

(72) Inventor: Peter Lazar, Janesville, WI (US)

(21) Appl. No.: 17/230,608

(22) Filed: Apr. 14, 2021

(51) Int. Cl. B27B 17/00; B25B 1/10; B25B 1/02; B25B 1/20

(52) U.S. Cl. CPC B27B 17/00; B25B 1/20; B25B 1/02; B25B 1/103

(57) ABSTRACT

An assembly for immobilizing a chainsaw that includes a platform. The platform having a proximal end and a distal end, and a top surface. The assembly having an upstanding anchor hook and a clamp coupled to the platform for immobilizing the chainsaw. The upstanding anchor hook is configured to receive a front handle of the chainsaw and the clamp is configured to receive a rear handle of the chainsaw, such as to restrict the horizontal and vertical movement of the chainsaw.

### FIELD OF INVENTION

The present invention relates to an assembly for immobilizing a chainsaw, and more particularly, the present invention relates to an assembly that allows starting a chainsaw by first immobilizing the chainsaw.

### BACKGROUND

A chainsaw is a mechanical power-driven cutting tool that cuts with a set of teeth attached to a chain that moves around the blade. Atypical chainsaw can be powered by a fuel engine. The blade extends from the housing, wherein the housing includes a driving mechanism, such as a gasoline engine for driving the chainsaw. The housing includes a fuel tank for storing gasoline. The housing also includes a front handle and a rear handle. The handles can be grabbed by a hand for holding the chainsaw. The engine can start by pulling the pull handle of the chainsaw.

To start the chainsaw, a person generally immobilizes the chainsaw on the ground. The rear handle can be secured by a leg while the front handle can be secured by hand. Using his free hand, the person can pull the handle for starting the chainsaw.

The above mechanism for starting the chainsaw is laborious and can often result in injury. Thus, a need is appreciated for an assembly to immobilize the chainsaw.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an assembly for immobilizing a chainsaw such as the chainsaw can be started by pulling the handle.

It is another object of the present invention that the assembly can be installed at a height such as a person starting the chainsaw does not have to bend.

It is another object of the present invention that the assembly provides for safely stowing the chainsaw.

It is yet another object of the present invention that the assembly is economical to manufacture and easy to use.

In one aspect, disclosed is an assembly for immobilizing a chainsaw, such as the chainsaw can be started by pulling a handle. The disclosed assembly includes a platform that can be installed at a height. The platform having a proximal end and a distal end. The platform having a top surface. An upstanding anchor hook extends from the top surface of the platform near its proximal end. The anchor hook can be configured to receive a front handle of the chainsaw, such as to restrict the vertical movement of the front handle. An upstanding shaft extends from the top surface of the platform near its distal end. An arm pivotally/swivelly coupled to the tip of the shaft, wherein the arm can be turned between an engaged state and a disengaged state. In the engaged state, the arm can turn into the rear handle of the chainsaw limiting the vertical movement of the rear handle. The arm can be turned outwards to disengage the rear handle. A knob can be provided on the arm for turning the arm between the engaged state and a disengaged state. The knob can also lock the arm in the engaged state. The height of the arm can be adjusted.

These and other objects and advantages of the embodiments herein and the summary will become readily apparent from the following detailed description taken in conjunction with the accompanying drawings

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of the assembly showing the platform, an upstanding anchor hook, and a clamp, according to an exemplary embodiment of the present invention.

FIG. 2 shows the chainsaw mounted on the platform and secured with the clamp and the anchor hook, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

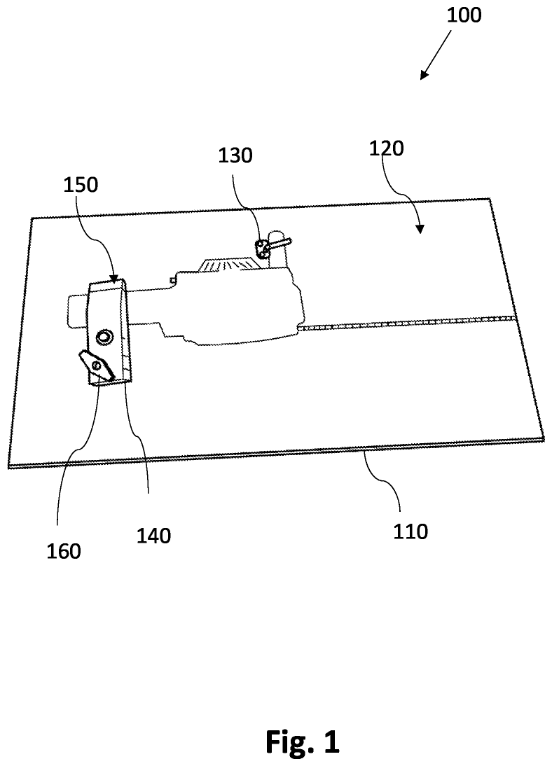

Referring to FIG. 1, which shows the disclosed assembly 100 that can be used to immobilize a chainsaw, such as a chainsaw can be started by pulling the pull handle of the immobilized chainsaw. The chainsaw 100 having a platform 110 that can have a proximal end and a distal end. Platform 110 having a top surface 120 on which the chainsaw can be mounted. The area of the top surface 120 of the platform 110 can be at least the length of the chainsaw between the front handle and the rear handle. The platform 110 can be made of any durable and rigid material, such as plywood, polycarbonate, metal, and like. In one case, the platform can be ¾ inch plywood that can support the chainsaw. The platform 110 can be installed at a height such as a tabletop, workbench, bed of a trailer, or pickup truck. The height of the platform can be around 2-3 feet above the ground, such as a user can pull the handle of the chainsaw without bending.

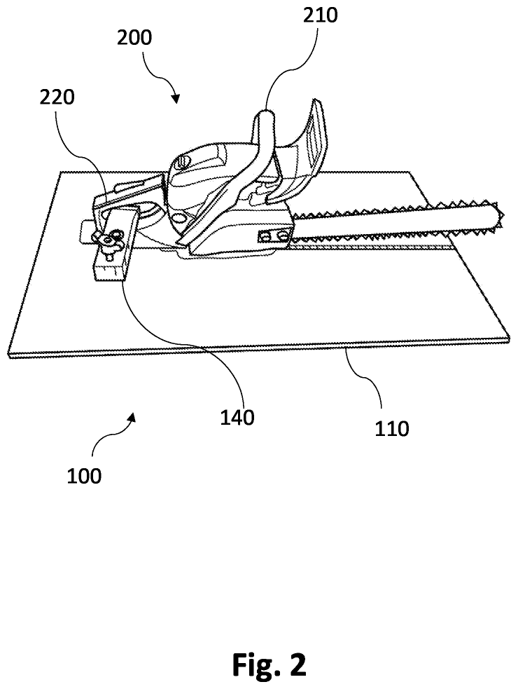

An upstanding anchor hook 130 can be installed near the proximal end of platform 110 on the top surface 120. As can be seen in FIG. 1, the upstanding anchor hook 130 can of an L-shape that can receive the front handle of the chainsaw. Shown in FIG. 2 is the chainsaw 200 mounted on platform 110. The front handle 210 of the chainsaw 200 can be received by the upstanding anchor hook 130 to restrict the vertical movement of the chainsaw. In one case, the height of the upstanding anchor hook 130 can be adjusted to accommodate the front handles of different widths. For example, the upstanding anchor hook 130 can have a screw mechanism that can be rotated clockwise and anticlockwise to increase or decrease the height of the upstanding anchor hook 130. The hook part of the upstanding anchor hook 130 can have a layer of rubber material to prevent any slippage of the front handle. The hook of the upstanding anchor hook 130 can be seen pointing towards the proximal end of the platform.

The assembly 100 can also have a clamp 140 installed near the distal end of the platform 110. The clamp 140 can have an upstanding shaft (not shown) extending from the top surface 120 near the distal end of the platform 110. To the shaft can be mounted an arm 150 to form a substantially L-shaped clamp. The arm can be perpendicularly mounted to the shaft, such as the rear handle 220 of the chainsaw 200 can be hooked by the clamp 140. The arm 150 can be turned relative to the shaft, such as to be switch between an engaged state and a disengaged state. In the engaged state, the arm can be hooked to the rear handle of the chainsaw. The arm can be turned outwards to disengage the rear handle. For turning the arm, the arm can be pivotally or swivelly mounted to the shaft. The clamp can also have a knob 160 coupled to the arm for rotating the arm either clockwise or anticlockwise, such as to switch the clamp between the engaged state and the disengaged state. In one case, the arm can be rotated 360 degrees relative to the shaft.

The height of the clamp can be adjusted such as to receive the rear handle of different widths. The length of the shaft can be varied, for example, the shaft can have threads and the arm can be threadedly coupled to the shaft. To decrease the height of the arm, the arm can be rotated such as the arm vertical moves downwards. To increase the height of the arm, the arm can be rotated in the reverse direction. In case, the arm is threadedly coupled to the shaft, the arm can be threadedly rotated to the desired height and engaged to the rear handle of the chainsaw. A locking screw can also be provided that can secure the position of the arm. In one case, the knob 160 shown in FIG. 1 can function as a locking screw that can restrict the rotation of the arm relative to the shaft.

In one case, the clamp can also have a locking mechanism to secure the clamp in the engaged position. The locking mechanism may restrict the rotation of the arm relative to the shaft. The upstanding anchor hook and the upstanding clamp prevents any vertical movement of the chainsaw. When both the anchor hook and the clamp are engaged to the chainsaw, both the horizontal and the vertical movements of the chainsaw can be restricted, thus immobilizing the chainsaw. The upstanding anchor hook and the clamp can be of sufficient durability, such as the pull handle of the chainsaw can be pulled for starting the chainsaw.

To immobilize the chainsaw, the front handle of the chainsaw can be hooked to the upstanding anchor hook and the chainsaw can rest on the platform. Thereafter, the arm of the clamp can be turned to the engaged state, hooked to the rear handle, immobilizing the chainsaw. The height of the clamp can be adjusted to hold to the rear handle of the chainsaw. The anchor hook and the clamp can be made of metal, such as stainless steel.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An assembly for immobilizing a chainsaw, the assembly comprising:
a platform having a proximal end and a distal end, the platform having a top surface;
an upstanding anchor hook extends from the top surface of the platform near its proximal end, the upstanding anchor hook configured to receive a front handle of a chainsaw restricting the vertical movement of the front handle; and
a clamp coupled to the distal end of the platform and configured to receive a rear handle of the chainsaw, the clamp configured to restricts vertical movement of the rear handle.

2. The assembly according to claim 1, wherein the upstanding anchor hook and the clamp configured to limit the horizontal and vertical movement of the chainsaw for immobilizing the chainsaw.

3. The assembly according to claim 1, wherein the clamp comprises an upstanding shaft that extends from the top surface of the platform and an arm swivelly coupled to the shaft, the arm configured to be switched between an engaged state and a disengaged state, in the engaged state, the arm is hooked to the rear handle of the chainsaw.

4. A method for immobilizing a chainsaw comprising:
providing an assembly, the assembly comprising:
a platform having a proximal end and a distal end, the platform having a top surface,
an upstanding anchor hook extends from the top surface of the platform near its proximal end, the upstanding anchor hook configured to receive a front handle of a chainsaw restricting a vertical movement of the front handle, and
a clamp coupled to the distal end of the platform and configured to receive a rear handle of the chainsaw, the clamp configured to restricts vertical movement of the rear handle;
hooking the front handle of the chainsaw to the upstanding anchor hook;
clamping the rear handle of the chainsaw to the clamp immobilizing the chainsaw; and
pulling the pull handle of the chainsaw.

5. The method according to claim 4, wherein the assembly is mounted to a workbench.

6. The method according to claim 4, wherein the upstanding anchor hook and the clamp are configured to limit the horizontal and vertical movement of the chainsaw for immobilizing the chainsaw.
